(19) United States
(12) Patent Application Publication
(10) Pub. No.: US 2014/0037405 A1
(43) Pub. Date: Feb. 6, 2014

(54) Warehouse System

(71) Applicants: Xiande Li, Shenzhen (CN); Chunhao Wu, Shenzhen (CN); Kunhsien Lin, Shenzhen (CN); Minghu Qi, Shenzhen (CN); Zhenghong Chen, Shenzhen (CN); Yongqiang Wang, Shenzhen (CN); Weibing Yang, Shenzhen (CN); Zhenghua Guo, Shenzhen (CN); Yunshao Jiang, Shenzhen (CN); Zhiyou Shu, Shenzhen (CN)

(72) Inventors: Xiande Li, Shenzhen (CN); Chunhao Wu, Shenzhen (CN); Kunhsien Lin, Shenzhen (CN); Minghu Qi, Shenzhen (CN); Zhenghong Chen, Shenzhen (CN); Yongqiang Wang, Shenzhen (CN); Weibing Yang, Shenzhen (CN); Zhenghua Guo, Shenzhen (CN); Yunshao Jiang, Shenzhen (CN); Zhiyou Shu, Shenzhen (CN)

(73) Assignee: SHENZHEN CHINA STAR OPTOELECTRONICS TECHNOLOGY CO. LTD., Shenzhen (CN)

(21) Appl. No.: 13/583,004

(22) PCT Filed: Aug. 6, 2012
(86) PCT No.: PCT/CN12/79715

§ 371 Date: Sep. 6, 2012

(30) Foreign Application Priority Data
Jul. 31, 2012 (CN) 201210269100.5

(51) Int. Cl. B65G 1/06

(52) U.S. Cl. 414/273

(57) ABSTRACT

A warehouse system including a temporary storage device and a stacking crane is disclosed. The stacking crane includes a rack and a goods support. The rack includes three sensors. The temporary storage device includes a lifted support and a roller support. The goods support, the lifted support and the roller support may be lifted vertically between its high level and low level. The temporary storage device includes three reflective plates arranged according. to the locations of the third high level of the roller support, the second high level of the lifted support and the lifted support. In addition, three sensors are configured to sense the three reflective plate and determines if the stacking crane has to be shut down according to the sensing results. The warehouse system is capable of preventing the stacking crane from crash accidents.

### BACKGROUND OF THE INVENTION

1. Field of the Invention

Embodiments of the present disclosure relate in large-scale warehouse technology, and more particularly to a warehouse system.

2. Discussion of the Related Art

Stacking crane is a warehouse device for retrieving, moving, or stacking goods from a high rack. In warehouse fields, temporary storage devices connect and operate in coordination with stacking cranes. Usually, the temporary storage device communicates with the stacking crane by signal connection lines to notify the stacking crane to retrieve the goods therefrom.

However, though the handshaking process between the temporary storage device and the stacking crane may be executed normally by the signal connection lines, industrial accidents may still happen. As shown, FIG. 1 is a flowchart illustrating an operating method of a conventional stacking crane. The operating method includes the following steps. In Step 101, the stacking crane operates in a normal mode. In Step 102, the stacking crane determines if a normal handshaking process between the stacking crane and the temporary storage device is executed. if yes, in Step 103, the stacking crane continues its operations is executed. If no, in Step 104, the stacking crane is shut down. Even though the handshaking process is executed normally, before Step 103 is executed or during the execution of Step 103, parts on the temporary storage device may not be in their designated location due to malfunction or improper assembly. As the stacking crane continues its operations without detecting the above errors, the crash may happen and the stacking crane may be shut down. The same crash incident may happen when the temporary storage device erroneously issues a preparation signal to retrieve the goods when the goods are already on the temporary storage device. Therefore, the conventional stacking crane is not safe enough.

### SUMMARY

The object of the claimed invention is to provide a warehouse system preventing the stacking cranes from crash accidents.

In one aspect, a ware house system including a stacking crane and a temporary storage device is disclosed. The stacking crane includes a rack and a goods support arranged within the rack. The goods support is lifted vertically between a first low level and a first high level. The rack includes a first sensor, a second sensor, as third sensor, and a fourth sensor. The temporary storage device includes a hollow-shaped lifted support, a roller support and a conveyor belt. The hollow-shaped lifted support is lifted vertically between a second low level and as second high level. The second high level, and the second low level of the lifted support respectively corresponds to the first high level and the first low level Of the goods support. The lifted support jointly connects with the goods support so as to transport the goods therebetween. The roller support is lifted vertically between a third high level and a thud lo level, and portions of the roller support passes through the lifted support. The third high level and the third low level of the roller support respectively corresponds to the second high level and the second low level of the lifted support. The conveyor belt is lifted according to the movement of the lifted support, and the lifted support jointly connects with the goods support by the conveyor belt. The temporary storage device is arranged with a first reflective plate, a second reflective plate, and a third reflective plate. The location of the first reflective plate corresponds to the third high level of the roller support. The location of the second reflective plate corresponds to the second high level of the lifted support. The location of the third reflective plate corresponds to the location of the lifted support. The conveyor belt is arranged with a fourth reflective plate. The first sensor, the second sensor, the third sensor respectively senses the first reflective plate, the second reflective plate, the third reflective plate, and the fourth reflective plate, and determines if the stacking crane has to he shut down according to sensing results. The lifted support of the temporary storage device retrieves the goods from the goods support when the goods support is in the first high level. The first sensor notifies the stacking crane to he shut down upon determining that the roller support is not in the third low level when the first, sensor has not sensed the first reflective plate. The second sensor notifies the stacking crane to be shut down upon determining there are goods on the lifted support when the second sensor has not sensed the second reflective plate. The third sensor notifies the stacking, crane to be shut down upon determining the lifted support is not in the second high level when the third sensor has not sensed the third reflective plate. The fourth sensor notifies the sacking crane to be shut down upon determining there are goods on the conveyor belt when the fourth sensor has not sensed the fourth reflective plate. The lifted support of the temporary storage device transports goods to the goods support when the goods support is in the high level. The first sensor notifies the stacking crane to be shut, down upon determining that the roller support is not in the third low level when the first sensor has not sensed the first reflective plate. The second sensor notifies the stacking crane to he shut down upon determining there are no goods on the lifted support when the second sensor has sensed the second reflective plate. The third sensor notifies the stacking, crane to he shut down upon determining the lifted support is not in the second high level when the third sensor has not sensed the third reflective plate. The fourth sensor notifies the stacking crane to he shut down upon determining there are goods on the conveyor belt when the fourth sensor has not sensed the fourth reflective plate.

There are a plurality of fourth reflective plate arranged with corresponding fourth sensors.

The first sensor, the second sensor, the third sensor, and the fourth sensor respectively emits infrared rays. The first reflective plate, the second reflective plate, the third. reflective plate and the fourth plate respectively reflects the infrared rays back to the first sensor, the second sensor, the third sensor, and the fourth sensor.

The first reflective plate, the second reflective plate, the third reflective plate and the fourth reflective plate are made of Acrylonitrile Butadiene Styrene(ABS).

In another aspect, a warehouse system includes a stacking crane and a temporary storage device is disclosed. The stacking crane includes a rack and a goods support arranged within the rack. The goods support is lilted vertically between a first low level and a first high level. The rack includes a first sensor, a second sensor, and a third sensor. The temporary storage device includes a hollow-shaped lifted support, and a roller support. The hollow-shaped lifted support is lifted vertically between a second low level and a second high level. The second high level and the second low level of the lifted support respectively corresponds to the first high level and the first low level of the goods support. The lifted support jointly connects with the goods support so as to transport the good therebetween. The roller support is lifted vertically between a third high level and a third low level, and portions of the roller support passes through the lifted support. The third high level and the third low level of the roller support respectively corresponds to the second high level and the second low level of the lifted support. The temporary storage device is arranged with a first reflective plate, a second reflective plate, and a third reflective plate. The location of the first reflective plate corresponding to the third high level of the roller support. The location of the second reflective plate corresponds to the second high level of the lilted support. The location of the third reflective plate corresponds to the location of the lifted support, and the first sensor, the second sensor and the third sensor respectively senses the first reflective plate, the second reflective plate, and the third reflective plate, and determines if the stacking crane has to be shut down according to sensing results.

The lifted support receives goods from the goods support when the goods support is in the first high level. The first sensor notifies the stacking crane to be shut down upon determining that the roller support is not in the third low level when the first sensor has not sensed the first reflective plate. The second sensor notifies the stacking crane to be shut down upon determining there are no goods on the lifted support when the second sensor has not sensed the second reflective, plate. The third sensor notifies the stacking crane to be shut down upon determining the lifted support is not in the second high level when the third sensor has not sensed the third reflective plate.

The lifted support transports goods to the goods support when the goods support is in the first low level. The first sensor notifies the stacking crane to be shut down upon determining that the roller support is not in the third low level when the first sensor has not sensed the first reflective plate. The second sensor notifies the stacking crane to be shut down upon determining there are goods on the lifted support when the second sensor has sensed the second reflective plate. The third sensor notifies the stacking crane to be shut down upon determining the lifted support is not in the second high level when the third sensor has not sensed the third reflective plate. The fourth sensor notifies the stacking crane to be shut down upon determining there are goods on the conveyor belt when the fourth sensor has not sensed the fourth reflective plate.

The temporary storage device further includes a conveyor belt, and the lifted support jointly connects with the goods support by the conveyor belt.

The conveyor belt further includes fourth reflective plates. The rack further includes fourth sensors to sense the fourth reflective plates. The fourth sensor notifies the stacking crane to be shut down upon determining that there are goods on the conveyor belt when the fourth sensors has not sensed the fourth reflective plates.

There are a plurality of fourth reflective plates arranged the corresponding fourth sensors.

The conveyor belt lifts according to the movement of the lifted support.

The first sensor, the second sensor, the third sensor, and the fourth sensor respectively emits infrared rays. The first reflective plate, the second reflective plate, the third reflective plate and the fourth plate respectively reflects the infrared rays back. to the first sensor, the second sensor, the third sensor, and the fourth sensor.

The first reflective plate. The second reflective plate. The third reflective plate and the fourth reflective plate ate made of Aerylonitrile Butadiene Styrene(ABS).

### BRIEF DESCRIPTION OF THE DRAWINGS

FIG. 1 is a flowchart illustrating, an operating method of a conventional stacking crane.

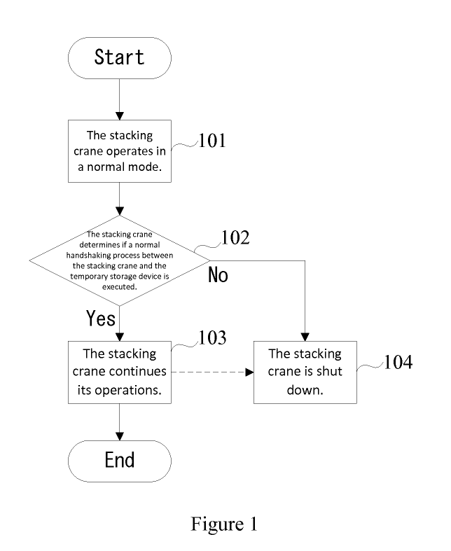

FIG. 2 is a schematic view of the structure of the stacking crane of one embodiment.

FIG. 3 is a schematic view of the structure of the temporary storage device of one embodiment.

FIG. 4 is an schematic view illustrating the retrieving process of the temporary storage device of one embodiment.

FIG. 5 is a flowchart illustrating an operating method of one embodiment of the warehouse system.

### DETAILED DESCRIPTION OF THE EMBODIMENTS

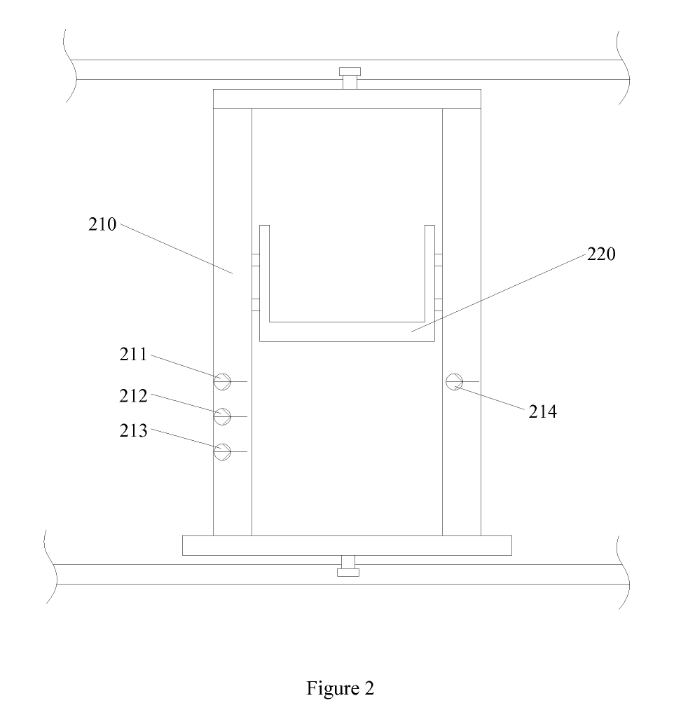

The warehouse system includes a temporary storage device and a stacking crane. FIG. 2 is a schematic view of the structure of the stacking crane of one embodiment. The stacking crane includes a rack 210, and a goods support 220 arranged within the rack. The goods support 220 may be lifted vertically between a first low level and a first high level. The first low level and the first high level may he adjusted according to real scenarios. The rack 210 includes a first sensor 211, a second sensor 212, and a third sensor 213.

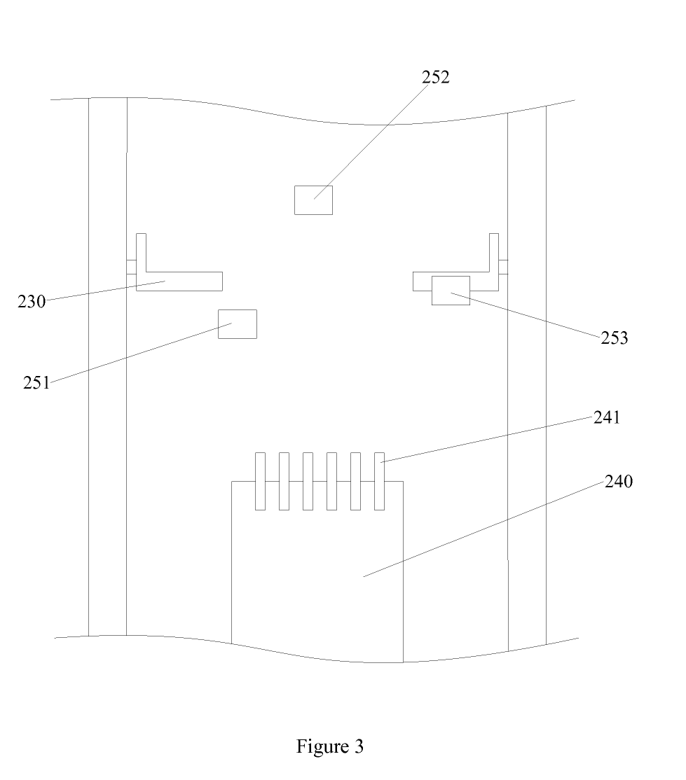

FIG. 3 is a schematic view of the structure of the temporary storage device of one embodiment. The temporary storage device includes a lifted support 230 and a roller support 240. The lifted support 210 is hollow-shaped and may be lifted vertically between a second low level and a second high level. The second high level and the second low level of the lifted support 230 respectively corresponds to the first high level and the first low level of the goods support 220. The lifted support 230 jointly connects with the goods support 220 so that the goods may be transported between the goods support 220 and the lifted support 230.

The roller support 240 may be lifted vertically between a third high level and a third low level, and portions of the roller support 240 may pass through the lifted support 230. The third high level and the third low level of the roller support 240 respectively corresponds to the second high level and the second low level, of the lifted support 230. The goods on the roller support 240 may be transported to the lilted support 230 by a number of roller wheels 241 on the roller support 240.

The temporary storage device includes a first reflective plate 251, a second reflective plate 252, and a third reflective plate 253. The location of the first reflective plate 251 corresponds to the third high level of the roller support 240. The location of the second reflective plate 252 corresponds to the second high level of the lifted support 230. The location of the third reflective plate 253 corresponds to the location of the filled support 230. The first reflective plate 251 and the second reflective plate 252 are fixed, and the third reflective plate 253 moves with the fitted support 230. The first sensor 211, the second sensor 212, and the third sensor 213 respectively senses the first reflective plate 251, the second reflective plate 252 and the third reflective plate 253, and the sensing result determines whether the stacking crane has to be shut down.

The sensing mechanisms of the first sensor 211, the second sensor 212, and the third sensor 213 are briefly described by using the first sensor 211 as an example. The first sensor 211 cannot sense the first reflective plate 251 when there are obstacles, such as the goods, on the sensing path of the first sensor 211 or the first reflective plate 251 is not in its predetermined location.

The temporary storage device further includes a conveyor belt (not labeled). The lilted support 230 jointly connects with the goods support 220 by the conveyor belt, The rack 210 of the stacking crane further includes a. fourth sensor 214 as shown in FIG. 2. Fourth reflective plates (not labeled) are arranged on the conveyor belt. The fourth sensor 214 determines that there are goods on the conveyor belt when the fourth sensor 214 has not sensed the fourth reflective plate. Thus, the fourth sensor 214 notifies the stacking crane to be shut down. In one embodiment, there are a plurality of fourth reflective plates. The rack 210 may includes a plurality of the fourth sensor 214, and each of the fourth sensor 214 corresponds to each of the fourth reflective plate. In addition, the conveyor belt may he lifted according to the movement of the lifted support 230.

Preferably, the first sensor 211, the second sensor 212, the third sensor 213. and the fourth sensor 214 respectively emits infrared rays. The first reflective plate 251, the second reflective plate 252, the third reflective plate 253 and the fourth plate respectively reflects the infrared rays back to the first sensor 211, the second sensor 211 the third sensor 213, and the fourth sensor 214. The sensors are configured to determine whether there are obstacles on its sensing path or the corresponding reflective plate is not on its predetermined location. In order to improve the reliability of the sensors, the first reflective plate 251, the second reflective plate 252, the third reflective plate 253 and the fourth reflective plate are made of Acrylonitrile Butadiene Styrene(ABS).

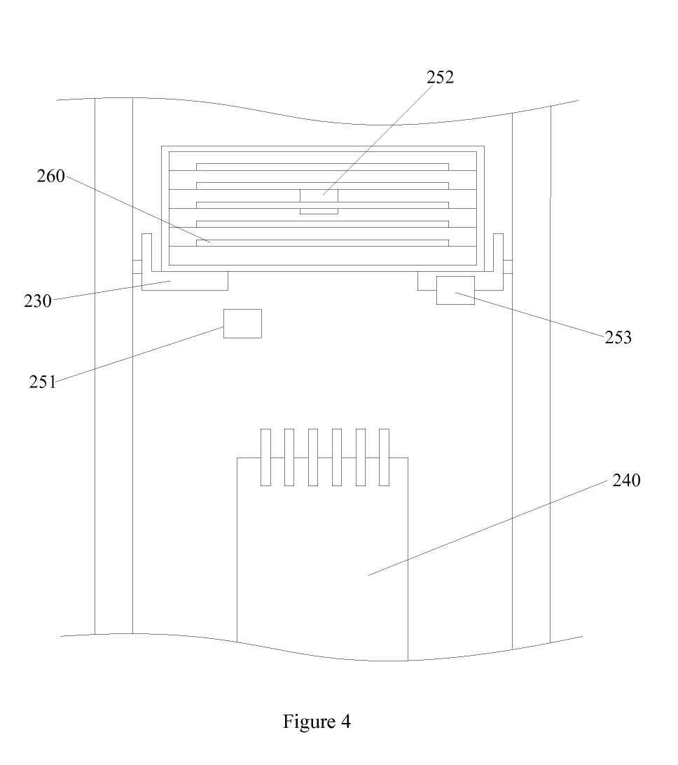

Please also referring to FIGS. 2, 3 and 4. FIG. 4 is an schematic view illustrating the retrieving process of the temporary storage device of one embodiment. The goods 260 is also shown in FIG. 4 for clearness.

When the lifted support 230 of the temporary storage device transports the goods 260 to the goods support 220 of the stacking crane, the goods support 220 is in the first high level. After confirming a normal handshaking process between the stacking crane and the temporary storage device, the stacking crane has to be shut down when the sensing result of any of the first sensor 211, the second sensor 212, and the third sensor 213 are abnormal. Specifically, the first sensor 211 determines that the roller support 240 in not in the third low level when the first sensor 211 has not sensed the first reflective plate 251, and thus the stacking crane has to be shut down. The second sensor 212 determines there are no goods 260 on the lifted support 230 when the second sensor 212 has not sensed the second reflective plate 252, and thus the stacking crane has to be shut down. The third sensor 213 determines the lifted support 230 is not in the second high level when the third sensor 213 has not sensed the third reflective plate 253, and thus the stacking crane has to be shut down.

In addition, the lifted support 230 of the temporary storage device May transport the goods 260 to the goods support 220 when the goods support 220 is in the first high level. Specifically, the first sensor 211 determines that the roller support 240 is not in the third low level when the first, sensor 211 has not sensed the first reflective plate 251 and thus the stacking crane has to be shut down. The second sensor 212 determines there are no goods 260 on the lifted support 230 when the second sensor 212 has sensed the second reflective plate 252, and thus the stacking crane has to be shutdown. The third sensor 213 determines the lifted support 230 is not in the second high level when the third sensor 213 has not sensed the third reflective plate 253, and thus the stacking crane has to be shut down.

The lifted support 230 of the temporary storage device may retrieve the goods 260 from the goods support 220 when the goods support 220 is in the first high level. Specifically, the first sensor 211 determines that the roller support 240 is not in the third low level when the first sensor 211 has not sensed the first reflective plate 251, and thus the stacking crane has to be shut down. The second sensor 212 determines there are goods 260 on the lilted support 230 when the second sensor 212 has not sensed the second reflective plate 252, and thus the stacking, crane has to be shutdown. The third sensor 213 determines the lifted support 230 is not in the second high level when the third sensor 213 has not sensed the third reflective plate 253, and thus the stacking crane has to be shut down.

It is obvious that the goods support 220 may retrieve the goods 260 even when the goods support 220 is in the first low level. Under the circumstance, the lifted support 230 is also in the second low level. Thus, an additional sensor has to be installed on the second low level of the lifted support 230. When the goods support 220 operates in the first low level, the retrieving process between the goods support 220 and the lifted support 230 are similar with the scenarios when the goods support 220 operates in the first high level.

Though the temporary storage device jointly connects with the stacking crane in the corresponding high level, the temporary storage device may jointly connect with other devices in the warehouse system in their corresponding level or low level. For example, the temporary storage device may jointly connect with other racks in the warehouse.

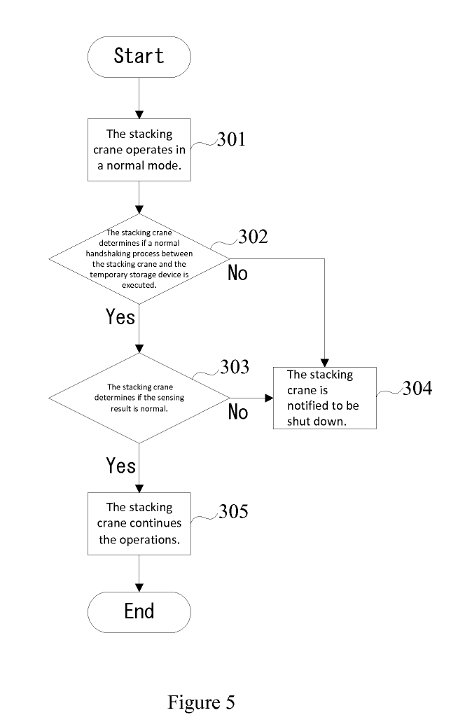

FIG. 5 is a flowchart illustrating an operating method of one embodiment of the warehouse system. The method includes the following steps. In Step 301 the stacking crane operates in a normal mode. In Step 302, the stacking crane determines if a normal handshaking process between the stacking crane and the temporary storage device is executed. If a normal handshaking process executed, in Step 303, the stacking crane determines if the sensing result is normal. If a normal handshaking process is not executed, in Step 304, the stacking crane is notified to he shut down. The handshaking process between the stacking crane and the temporary storage device is conducted by signal connection lines. If the sensing result is determined as normal in Step 303, in Step 305, the stacking crane continues the operations. if not, the stacking crane is notified to be shut down. The sensing mechanisms applied when the stacking crane operates in the low level and the high level are similar with the above-mentioned disclosure.

In view of the above, the rack of the stacking crane includes at least three sensors, respectively corresponding to the three reflective plates located on the third high level of the roller wheels, the second high level of the lifted support and the lifted support. The three sensors respectively senses the three reflective plates. The sensing results are used to determine if the stacking crane has to be shut down so as to decrease the industrial accident.

It is believed that the present embodiments and their advantages will he understood from the foregoing description, and it will be apparent that various changes may be made thereto without departing, from the spirit and scope of the invention or sacrificing all of its material advantages, the examples hereinbefore described merely being preferred or exemplary embodiments of the invention.

What is claimed is:

1. A warehouse system, comprising:
a stacking crane comprising a rack and a goods support arranged within the rack, the goods support being lifted vertically between a first low level and a first high level, the rack comprising a first sensor, a second sensor, a third sensor, and a fourth sensor; and
a temporary storage device comprising:
a hollow-shaped lifted support being lifted vertically between a second low level and a second high level, the second high level and the second low level of the lifted support respectively corresponding to the first high level and the first low level of the goods support, the lifted support jointly connecting with the goods support so as to transport the goods therebetween;
a roller support being lifted vertically between a third high level and a third low level, portions of the roller support passing through the lifted support, and the third high level and the third low level of the roller support respectively corresponding to the second high level and the second low level of the lifted support;
a conveyor belt being lifted according to the movement of the lifted support, and the lifted support jointly connecting with the goods support by the conveyor belt;
wherein the temporary storage device being arranged with a first reflective plate, a second reflective plate, and a third. reflective plate, the location of the first reflective plate corresponding to the third high level of the roller support, the location of the second reflective plate corresponding to the second high level of the lifted support, and the location of the third reflective plate corresponding to the location of the lifted support, the conveyor belt being arranged with a fourth reflective plate, and the first sensor, the second sensor, the third sensor respectively sensing the first reflective plate, the second reflective plate, the third reflective plate, and the fourth reflective plate, and determining if the stacking crane has to be shut down according to sensing results;
the lifted support of the temporary storage device retrieves the goods from the goods support when the goods support is in the first high level, the first sensor notifies the stacking crane to be shut down upon determining that the roller support is not in the third low level when the first sensor has not sensed the first reflective plate, the second sensor notifies the stacking crane to be shut down upon determining there are goods on the lifted support when the second sensor has not sensed the second reflective plate, the third sensor notifies the stacking crane to be shut down upon determining the lifted support is not in the second high level when the third sensor has not sensed the third reflective plate, the fourth sensor notifies the stacking crane to be shut down upon determining there are goods on the conveyor belt when the fourth sensor has not sensed the fourth reflective plate;
the lifted support of the temporary storage device transporting goods to the goods support when the goods support is in the high level, the first sensor notifies the stacking crane to be shut down upon determining that the roller support is not in the third low level when the first sensor has not sensed the first reflective plate, the second sensor notifies the stacking crane to be shut down upon determining there are no goods on the lifted support when the second sensor has sensed the second reflective plate, the third sensor notifies the stacking crane to be shut down upon determining the lifted support is not in the second high level when the third sensor has not sensed the third reflective plate, the fourth sensor notifies the stacking crane to be shut down upon determining there are goods on the conveyor belt when the fourth sensor has not sensed the fourth reflective plate.

2. The warehouse system as claimed in claim 1, wherein the there are a plurality of fourth reflective plate arranged with corresponding fourth sensors.

3. The warehouse system as claimed in claim 1, wherein the first sensor. the second sensor, the third sensor, and the fourth sensor respectively emits infrared rays, and the first reflective plate, the second reflective plate, the third reflective plate and the fourth plate respectively reflects the infrared rays back to the first sensor, the second sensor, the third sensor, and the fourth sensor.

4. The warehouse system as claimed in claim 1, wherein the first reflective plate, the second reflective plate, the third reflective plate and the fourth reflective plate are made of Acrylonitrile Butadiene Styrene(ABS).

5. A warehouse system, comprising:
a stacking crane comprising a rack and a goods support arranged within the rack, the goods support being lifted vertically between a first low level and a first high level, the rack comprising a first sensor, a second sensor, and a third sensor; and
a temporary storage device comprising:
a hollow-shaped lifted support being lifted vertically between a second low level and a second high level, the second high level and the second low level of the lifted support respectively corresponding to the first high level and the first low level of the goods support, the lifted support jointly connecting with the goods support so as to transport the good therebetween;
a roller support being lifted vertically between a third high level and a third low level, and portions of the roller support passing through the lifted support, the third high level and the third low level of the roller support respectively corresponding to the second high level and the second low level of the lifted support;
wherein the temporary storage device being arranged with a first reflective plate, a second reflective plate, and a third reflective plate, the location of the first reflective plate 251 corresponding to the third high level of the roller support, the location of the second reflective plate corresponding to the second high level of the lifted support, and the location of the third reflective plate corresponding to the location of the lifted support, and the first sensor, the second sensor, the third sensor respectively sensing the first reflective plate, the second reflective plate, the third reflective plate, and determines if the stacking crane has to be shut down according to sensing results;

6. The warehouse system as claimed in claim 5, wherein the lifted support receives goods From the goods support when the goods support is in the first high level, the first sensor notifies the stacking crane to be shut down upon determining that the roller support is not in the third low level when the first sensor has not sensed the first reflective plate, the second sensor notifies the stacking crane to he shut down upon determining there are no goods on the lifted support when the second sensor has not sensed the second reflective plate, and the third sensor notifies the stacking crane to be shut down upon determining the lifted support is not in the second high level when the third sensor has not sensed the third reflective plate.

7. The warehouse system as claimed in claim 5, wherein the lifted support transports goods to the goods support when the goods support is in the first low level, the first sensor notifies the stacking crane to be shut down upon determining that the roller support is not in the third low level when the first sensor has not sensed the first reflective plate, the second sensor notifies the stacking crane to be shut down upon determining there are goods on the lifted support when the second sensor has sensed the second reflective plate, the third sensor notifies the stacking crane to be shut down upon determining the lifted support is not in the second high level when the third sensor has not sensed the third reflective plate, the fourth sensor notifies the stacking crane to be shut down upon determining there are goods on the conveyor belt when the fourth sensor has not sensed the fourth reflective plate.

8. The warehouse system as claimed in claim 5, wherein the temporary storage device further comprises a conveyor belt, and the lifted support jointly connects with the goods support by the conveyor belt.

9. The warehouse system as claimed in claim 8, wherein the conveyor belt further comprises fourth reflective plates, and the rack further comprises fourth sensors to sense the fourth reflective plates, and the fourth sensor notifies the stacking crane to be shut down upon determining that there are goods on the conveyor belt when the fourth sensors has not sensed the fourth reflective plates.

10. The warehouse system as claimed in claim 9, wherein there are a plurality of fourth reflective plates arranged the corresponding fourth sensors.

11. The warehouse system as claimed in claim 8, wherein the conveyor belt lifts according to the movement of the lifted support.

12. The warehouse system as claimed in claim 5, wherein the first sensor, the second sensor, the third sensor, and the fourth sensor respectively emits infrared rays, and the first reflective plate, the second reflective plate, the third reflective plate and the fourth plate respectively reflects the infrared rays back to the first sensor, the second sensor, the third sensor, and the fourth sensor.

13. The warehouse system as claimed in claim 5, wherein the first reflective plate, the second reflective plate, the third reflective plate and the fourth reflective plate are made of Acrylonitrile Butadiene Styrene(ABS).
